(19) United States
(12) Patent Application Publication
(10) Pub. No.: US 2025/0249630 A1
(43) Pub. Date: Aug. 7, 2025

(54) METHOD AND DEVICE FOR OPERATING AN INJECTION MOLDING TOOL ACCORDING TO THE VISCOSITY INDEX OF THE MELT

(71) Applicant: Kistler Holding AG, Winterthur (CH)

(72) Inventor: Robert VACULIK, Konstanz (DE)

(21) Appl. No.: 19/045,757

(22) Filed: Feb. 5, 2025

(30) Foreign Application Priority Data
Feb. 7, 2024 (EP) 24156244.6

(51) Int. Cl. B29C 45/77

(52) U.S. Cl. CPC B29C 45/77; B29C 2945/76006; B29C 2945/7605; B29C 2945/76257; B29C 2945/76531; B29C 2945/76551; B29C 2945/76595; B29C 2945/76665

(57) ABSTRACT

A method and device is provided for operating an injection molding machine. The method uses the device, which is configured for determining the viscosity index of a melt in a cavity of an injection molding tool. The device includes pressure sensor member that measures an internal mold pressure of the melt in the cavity. The device includes an evaluation member configured for evaluating sensor data generated by the pressure sensor member. The evaluation member is configured to determine the viscosity index of the melt from the evaluated sensor data. The evaluation member is configured to compare the viscosity index to a target viscosity index and accordingly adjust operation of the machine's operating parameters so that the viscosity index of the melt conforms to the target viscosity index indicative of production of an acceptable part by the injection molding machine.

### FIELD OF THE INVENTION

The invention relates to a method and a device for operating an injection molding tool according to the viscosity of the melt by employing a pressure sensor measuring mold pressures inside a cavity receiving the injected melt and an evaluation member that evaluates the pressures measured by the sensor.

### BACKGROUND OF THE INVENTION

Injection molding is a cyclical process in which an injection molding machine produces at least one manufactured item in repetitive cycles over time. Each cycle comprises a plurality of phases. The injection molding machine comprises an injection molding tool that comprises a cavity. A material is injected into the cavity as a melt in an injection phase. The melt within the cavity is hotter compared to the material. The melt flows along a flow path and fills the cavity. A pressure increase takes place. The melt adopts the shape of the cavity. In a holding pressure phase, the melt within the cavity is compressed and further melt is supplied to compensate for a volume contraction as much as possible. The melt within the cavity cools down during a cooling phase. The cooled melt forms the manufactured item. Finally, the manufactured item is removed from the cavity.

In injection molding, it is important to keep the process parameters constant from cycle to cycle in order to ensure a consistently high quality of the manufactured items. One of these process parameters is the viscosity of the melt. The viscosity is indicative of the resistance that the melt must overcome when flowing along the flow path. When the viscosity increases, for example due to variations in the properties of the material or a change in the moisture content of the material, the resistance during filling of the cavity increases. As a result, the cavity may be incompletely filled with melt which may lead to the formation of a defective molded part and, thus, is undesirable.

The viscosity can be represented as a proportionality factor relating shear stress and shear rate. During filling, the shear stress is proportional to the pressure of the melt at a specific position on the flow path. The shear rate is proportional to the flow rate of the melt in the cavity. When the geometry of the flow path is known, it is possible to use the increase in pressure and the flow rate for determining a viscosity index that is proportional to the actual viscosity of the melt within the cavity.

To that end, the document WO2009040077A1, which is related to US Patent Publication No. 20100252944, which is hereby incorporated herein for all purposes by this reference, discloses a method for determining the viscosity index of a melt in an injection molding tool. A pressure sensor and a temperature sensor are arranged in the cavity. The pressure sensor is located in the proximity of the melt inlet into the cavity while the temperature sensor is arranged at the end of the flow path of the cavity. During filling of the cavity with melt the pressure sensor measures the internal pressure of the mold and the temperature sensor measures the temperature at the cavity wall. The shear stress is determined from the rise in pressure from the internal mold pressure of the empty cavity to the pressure at the time when the melt reaches the temperature sensor and the latter generates a temperature signal indicating that the cavity is filled with melt up to the position of the temperature sensor. The flow rate is determined from the time difference between the time when the pressure sensor measures the beginning of an increase in internal mold pressure and the time when the temperature sensor measures the beginning of a temperature increase at the end of the flow path. Afterwards, the viscosity index can be calculated from the ratio of shear stress and flow rate.

### OBJECTS AND SUMMARY OF THE INVENTION

It is a first object of the present invention to describe an injection molding machine that operates, or that can be retrofitted to operate, an injection molding tool that is configured to consistently produce acceptable parts. It is a related object to describe a method for operating the injection molding machine and the injecting molding tool. In connection with the operation of the injection molding tool to produce acceptable parts on a consistent basis, it is a further object to improve the method known from the document WO2009040077A1 for determining the viscosity index of a melt in an injection molding tool. Furthermore, it is an object of the invention to provide a device that can be retrofitted to an injection molding machine and enables a cost-effective determination of the viscosity index of a melt in an injection molding tool.

At least one of these objects has been achieved by the features described herein.

The invention relates to a method for operating an injection molding machine that relies on determining a viscosity index of a melt in an injection molding tool that comprises at least one cavity into which the melt is injected and fills the cavity; a pressure sensor member arranged at the cavity and measuring an internal mold pressure of the melt within the cavity and generating sensor data for the internal mold pressure measured; and that comprises at least one evaluation member configured for evaluating the sensor data; wherein said evaluation is characterized by the following steps of:
determining a starting time point where the sign of a first derivative function of the sensor data changes from zero to positive;
determining a filling time point where the sign of a second derivative function of the sensor data changes from zero to positive;
calculating a pressure increase between the internal mold pressure at the filling time point and the internal mold pressure at the starting time point; and
calculating the viscosity index from said pressure increase and a time difference between the filling time point and the starting time point.

The invention also relates to a device that can be provided as original equipment to an injection molding machine or retrofitted to a pre-existing injection molding machine, which device is configured for determining a viscosity index of a melt in an injection molding tool wherein said device further comprises, in addition to the injection molding tool, a pressure sensor member and at least one evaluation member; which injection molding tool comprises at least one cavity into which the melt can be injected and which can be filled with injected melt; wherein the pressure sensor member is arranged at the cavity and measures an internal mold pressure of the injected melt within the cavity and generates sensor data for the internal mold pressure measured; wherein the evaluation member is configured for evaluating the sensor data; wherein said evaluation is characterized in that:
the evaluation member determines a starting time point where the sign of a first derivative function of the sensor data changes from zero to positive;
the evaluation member determines a filling time point where the sign of a second derivative function of the sensor data changes from zero to positive;
the evaluation member calculates a pressure increase between the internal mold pressure at the filling time point and the internal mold pressure at the starting time point; and
the evaluation member calculates the viscosity index from said pressure increase and the time difference between the filling time point and the starting time point.

The applicant has surprisingly found that in contrast to the teaching of the document WO2009040077A1, the viscosity index of a melt within a cavity can be determined by using just one pressure sensor member and without using a temperature sensor. Thereby, the determination of the viscosity index will be cost-effective.

The invention takes advantage of the finding that the flow behavior of the melt within the cavity satisfies the Hagen-Poiseuille law. Accordingly, the increase in pressure of the melt during filling of the cavity is proportional to the product of viscosity and volume flow. At the filling time point, the viscosity of the melt is therefore proportional to the product of the pressure increase and the time difference on the flow path. This enables a reliable, simple and quick determination of the viscosity index.

Further embodiments of the object of the invention are described herein.

### BRIEF DESCRIPTION OF THE DRAWINGS

In the following, the invention will be explained in more detail by way of example referring to the figures in which:

FIG. 1 schematically shows a portion of a device V comprising an injection molding machine 1 for producing manufactured items W;

FIG. 2 shows a graphical representation of sensor data XD(tᵢ, i=1 . . . n) obtained during the production of a manufactured item W by the injection molding machine 1 according to FIG. 1; and

FIG. 3 shows an enlarged view of a portion of the graphical representation of sensor data XD(tᵢ, i=1 . . . n) according to FIG. 2.

Throughout the figures, the same reference numerals indicate the same objects.

### DETAILED DESCRIPTION OF EXEMPLARY EMBODIMENTS OF THE INVENTION

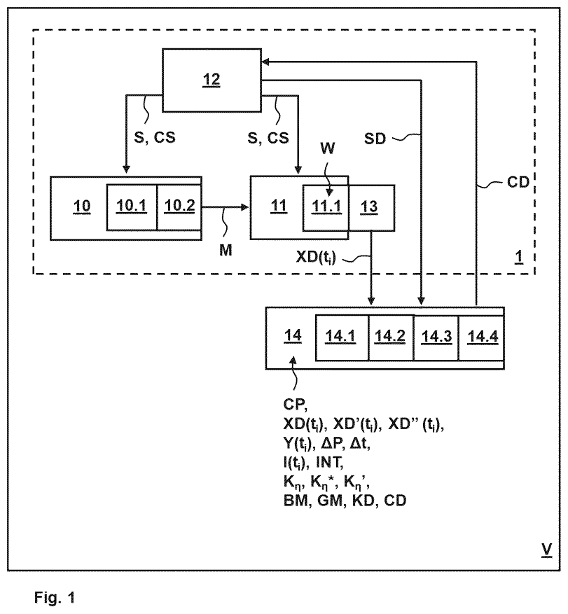

FIG. 1 schematically shows an injection molding machine 1 that is provided with a device V, which can be included as original equipment of the injection molding machine or can be retrofitted to a pre-existing injection molding machine 1. The device is configured as described herein with the capability for determining the viscosity r of a melt M in at least one injection molding tool 11 of the injection molding machine 1.

The injection molding tool 11 desirably is a component of a commercially available injection molding machine 1 well-known to those skilled in the art for producing at least one manufactured item W.

Injection molding is a cyclical process in which the injection molding machine 1 produces the manufactured item W in repetitive cycles over time. Each cycle during which a respective manufactured item W is produced comprises an injection phase I, a holding pressure phase II and a cooling phase Ill. A cycle may last several seconds during which all three phases I, II, 11 are consecutively completed.

A component of the injection molding machine 1 is at least one injection device 10 comprising a screw 10.1 and a nozzle 10.2. A starting material is liquefied by means of the screw 10.1 to form a melt M that is moved towards the nozzle 10.2. The melt M, which is schematically represented by the arrow designated M, may consist of plastic, metal, ceramics etc.

The injection molding tool 11 comprises at least one cavity 11.1. In the injection phase I, as schematically indicated by the direction of the arrow designated M in FIG. 1, the melt M is injected through the nozzle 10.2 into the cavity 11.1. The melt within the cavity 11.1 is hotter compared to the starting material. The melt M flows along a flow path within the cavity 11.1 and fills the cavity 11.1. An increase in pressure occurs. The melt M adopts the shape of the cavity 11.1 when the melt M has filled the cavity 11.1. In the holding pressure phase II, the melt M within the cavity 11.1 is compressed and further melt M is supplied to compensate for a volume contraction as much as possible. In the cooling phase III, the melt M cools down in the cavity 110. The cooled melt M forms the manufactured item W. Finally, the manufactured item W is removed from the cavity 11.1.

A component of the injection molding machine 1 is at least one control member 12. The control member 12 is configured for controlling the production of the manufactured item W by at least one of the following machine setting variables S:
a metering speed of the screw 10.1,
an injection speed of the melt M,
a temperature of the melt M,
a filling time point t_{II}.

The control member 12 is connected by signal lines to the injection device 10 and the injection molding tool 11 for this purpose and controls the injection device 10 and the injection molding tool 11 through the signal lines by means of the machine setting variable S. The control member 12 generates machine setting data SD for the machine setting variable S. The machine setting data SD are digital data.

A component of the injection molding tool 11 is a pressure sensor member 13 for each cavity 11.1. The pressure sensor member 13 is arranged at the cavity 11.1. The pressure sensor member 13 is configured for measuring the internal mold pressure P of the melt M within the cavity 11.1. The pressure sensor member may comprise a piezoelectric pressure sensor, a piezoresistive pressure sensor, a strain gauge, etc.

The pressure sensor member 13 preferably comprises a piezoelectric pressure sensor that generates electrical polarization charges under the action of the internal mold pressure P. The amount of electrical polarization charges generated is proportional to the amount of the internal mold pressure P. Generally, the piezoelectric pressure sensor measures the internal mold pressure P with a measurement accuracy of 1%. Furthermore, the piezoelectric pressure sensor typically measures the internal mold pressure P with a temporal resolution of less than/equal to 0.01 Hz. The pressure sensor member 13 may comprise an amplifier member for the piezoelectric pressure sensor for amplifying the electrical polarization charges to give sensor data XD(tᵢ). The sensor data index i indicates the individual sensor data XD(tᵢ) at the time points tᵢ, i=1 . . . n and the sensor data number n indicates the number of sensor data XD(tᵢ). The sensor data XD(tᵢ) follow each other in time at the time points tᵢ, i=1 . . . n and are preferably constantly spaced in time from each other. Preferably, the sensor data XD(tᵢ) are digital data. Thus, for a cycle that typically lasts for a time of t=10 sec, the piezoelectric pressure sensor measures the internal mold pressure P at least 1000 times and generates a temporal sequence of at least 1000 sensor data XD(tᵢ).

A component of the device V is at least one evaluation member 14. The evaluation member 14 comprises at least one data processor 14.1, at least one data memory 14.2, at least one output member 14.3 and at least one input member 14.4. At least one computer program CP is stored in the data memory 14.2 and can be loaded into the data processor 14.1. The evaluation member 14 is connected by signal lines to the control member 12 and to the pressure sensor member 13. The evaluation member 14 receives the machine setting data MS generated by the control member 12 through the signal lines and receives the sensor data XD(tᵢ) generated by the pressure sensor member 13.

The computer program CP loaded into the data processor 14.1 causes the evaluation member 14 to load sensor data XD(tᵢ, i=1 . . . n) into the data processor 14.1 and to analyze the loaded sensor data XD(tᵢ). Due to the computer program CP loaded into the data processor 14.1, the evaluation member 14 is configured for loading the sensor data XD(tᵢ, i=1 . . . n) into the data processor 14.1 and to evaluate the loaded sensor data XD(tᵢ).

A result of the evaluation of the sensor data XD(tᵢ) by the evaluation member 14 is the graphical representation of the sensor data XD(tᵢ). The sensor data XD(tᵢ, i=1 . . . n) can be represented as a mathematical function of the internal mold pressure inside the cavity 11.1 versus time. As a mathematical function, the sensor data XD(tᵢ) may be plotted as the graph of a function Y(tᵢ) in a coordinate system. The coordinate system comprises an ordinate and an abscissa. The ordinate is the internal mold pressure P measured, the abscissa are the time points tᵢ, i=1 . . . n where the sensor data XD(tᵢ) were generated. The graph of a function Y(tᵢ) is also referred to as the mold internal pressure curve Y(tᵢ).

The graphical representation of the sensor data XD(tᵢ) may be displayed on the output member 14.3. Preferably, the output member 14.3 is a screen so that an operator of the injection molding machine 1 is able to see the graphical representation of the sensor data XD(tᵢ) displayed on the screen.

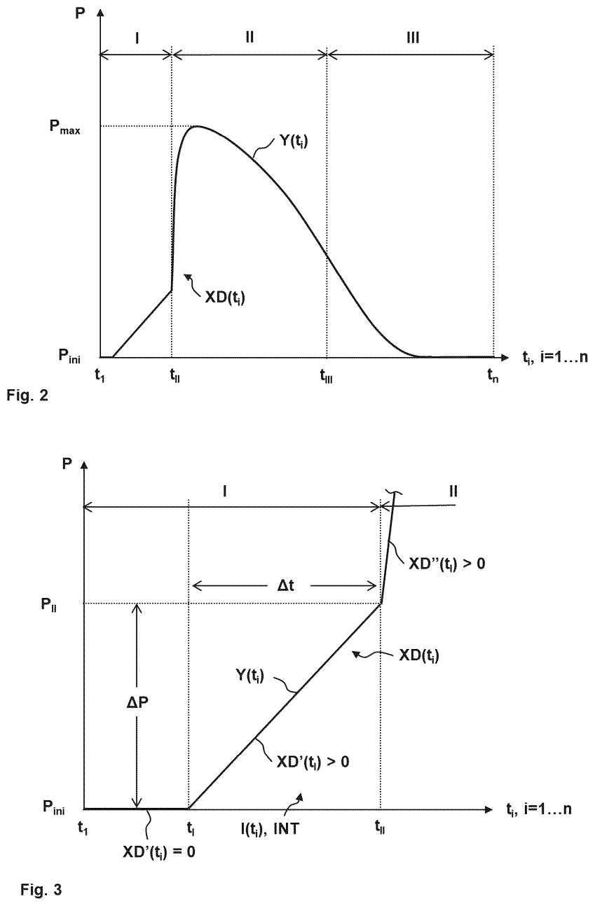

FIG. 2 shows a graphical representation of the sensor data XD(tᵢ). The graphical representation of the sensor data XD(tᵢ) shows the time course from the injection phase I until the cooling phase III:

As schematically shown in FIG. 2, the injection phase I starts at a time point tᵢ at an initial internal mold pressure Pᵢₙᵢ. At the beginning of the injection phase I, no change in the initial internal mold pressure Pᵢₙᵢ will occur for some time due to the position of the pressure sensor member 13 within the cavity 11.1, and during that time the form of the internal mold pressure curve Y(tᵢ) remains flat until the melt M reaches the position of the pressure sensor member 13. The cavity 11.1 is filled with further melt M and within a short period of time the internal mold pressure curve Y(tᵢ) rises steeply from the initial internal mold pressure Pᵢₙᵢ up to a maximum internal mold pressure Pₘₐₓ. The time point t_{II} when the cavity 11.1 is completely filled with melt M is identified in FIG. 2 and also referred to as the filling time point t_{II}. The injection phase I is finished when the cavity 11.1 is completely filled at time t_{II}, and then the holding pressure phase II starts also at time t_{II}.

In the holding pressure phase II, the melt M is compressed within the cavity 11.1. The injection device 10 exerts a holding pressure at the nozzle 10.2 onto the melt M in the cavity 11.1 in the holding pressure phase II. Furthermore, more melt M flowing into the cavity 11.1 compensates for shrinkage of the cooling melt M. The internal mold pressure curve Y(tᵢ) first rises steeply and then descends again. The melt M is solidified within the cavity 11.1. The holding pressure phase II ends at a time point t_{III}. The time point t_{III} is also referred to as the sealing point t_{III} when the melt M in the area of the nozzle 10.2 of the injection device 10 has solidified to such an extent that additional melt M cannot flow into the cavity 11.1, and thus the entrance to the cavity 11.1 is sealed. Once the entrance to the cavity is sealed by the solidified melt M, then the cooling phase III starts as schematically shown in FIG. 2.

In the cooling phase III, the melt M cools further down within the cavity 110. The internal mold pressure curve Y(tᵢ) continues to descend as the magnitude of the internal mold pressure diminishes over time beyond time point t_{III}. The cooling phase III ends at the time point to schematically shown in FIG. 2, and the completed manufactured item W is removed from the cavity 11.1 at the time point to.

FIG. 3 shows an enlarged view of a portion of the graphical representation of the sensor data XD(tᵢ) according to FIG. 2. The portion shown in FIG. 3 covers the entire injection phase I and the beginning of the holding pressure phase II.

As a mathematical function, the sensor data XD(tᵢ) can be mathematically differentiated. One result of the analysis of the sensor data XD(tᵢ) by the evaluation member 14 is the differentiation of the sensor data XD(tᵢ). The differentiation provides information about the slope, the bend etc. of the internal mold pressure curve Y(tᵢ). The evaluation member 14 calculates at least a first derivative function XD′(tᵢ) of the sensor data XD(tᵢ). The evaluation member 14 calculates at least a second derivative function XD″(tᵢ) of the sensor data XD(tᵢ).

The first derivative function XD′(tᵢ, i=1 . . . n) provides information about the time point when the internal mold pressure curve Y(tᵢ, i=1 . . . n) starts to rise. At a starting time point tᵢ, the sign of the first derivative function XD′(tᵢ) changes from zero (=0) to positive (>0). Then, the mold internal pressure curve Y(tᵢ) that is flat until the starting time point tᵢ in the injection phase I starts to rise. The internal mold pressure curve Y(tᵢ) rises substantially monotonically, i.e. the ascend of the internal mold pressure curve Y(tᵢ) is substantially constant in relation to the time over which the pressure is rising.

The second derivative function XD″(tᵢ) provides information about the bend of the internal mold pressure curve Y(tᵢ). At the filling time point t_{II}, the sign of the second derivative function XD″(t_{II}) changes from zero (=0) to positive (>0). The ascend of the internal mold pressure curve Y(tᵢ) that is substantially constant until the filling time point t_{II} is reached starts to increase from the filling time point t_{II}, the internal mold pressure curve Y(tᵢ) is bent to the left. At the filling time point t_{II}, the cavity 11.1 is completely filled with melt M and a filling pressure Pu is measured.

Now, the flowing behavior of the melt M in the cavity 11.1 satisfies the Hagen-Poiseuille law. Accordingly, the pressure increase ΔP of the melt M during filling of the cavity 11.1 is proportional to the product of the viscosity q and the volume flow rate Q. ΔP=k*η*Q

The proportionality factor k accounts for the geometry of the cavity 11.1. At the filling time point t_{II}, it is possible to calculate the viscosity n of the melt M in the cavity 11.1 as a viscosity index Kn. The viscosity index K_{η} is proportional to the actual viscosity n of the melt M within the cavity 11.1 at the filling time point t_{II}. The viscosity index K_{η} is calculated from the product of the pressure increase ΔP and the time difference Δt on the flow path.

The viscosity index K_{η} can be determined mathematically by integrating the sensor data XD(tᵢ). Therefore, a result of the evaluation of the sensor data XD(tᵢ) by the evaluation member 14 is the integration of the sensor data XD(tᵢ, i=1 . . . n). The evaluation member 14 calculates a specific integral I(tᵢ) of the sensor data XD(tᵢ) between the filling time point t_{II} and the starting time point tᵢ:

I(tᵢ)=∫t_{I}t^{II}XD(tᵢ)dtᵢ

The viscosity index K_{η} is equivalent to the specific integral I(tᵢ). When represented graphically as in FIG. 3, the viscosity index K_{η} is the right triangle-shaped area INT under the internal mold pressure curve Y(tᵢ, i=1 . . . n) and the abscissa between the filling time point t_{II} and the starting time point tᵢ in FIG. 3.

The computer program CP loaded into the data processor 14.1 is configured to cause the evaluation member 14 to evaluate the sensor data XD(tᵢ) and to determine a target viscosity index K_{η}*. The target viscosity index K_{η}* is proportional to the viscosity r at which the injection molding machine 1 produces a manufactured item W of high quality, a so-called good part in the sense that the item W is commercially acceptable. Whether a manufactured item W is a good part or not, is determined by a quality control step based on at least one quality characteristic such as a specified dimensional accuracy, absence of parting lines or casting defects (short shots) etc. When the quality characteristic is not fulfilled, then the part is considered as a bad part.

Preferably, the target viscosity index K_{η}* is determined in a test operation during setting up of the injection molding machine 1 before the start of the actual operation of the injection molding machine 1 starts to produce multiple good parts that satisfy the selected quality characteristic. The target viscosity index K_{η}* is stored in the data memory 14.2.

During operation of the injection molding machine 1, the viscosity index K_{η} is determined for each cycle during which a manufactured item W is produced. It is determined in real time, i.e., the determination of the viscosity index K_{η} of a current cycle is completed before the next cycle in the chronological sequence starts. The viscosity index K_{η} that was determined for a cycle can be stored in the data memory 14.2.

The computer program CP loaded into the data processor 14.1 causes the evaluation member 14 to load the target viscosity index K_{η}* into the data processor 14.1 and to compare the viscosity index K_{η} determined for the current cycle with the loaded target viscosity index K_{η}*. By the computer program CP loaded into the data processor 14.1, the evaluation member 14 is configured to load the target viscosity index K*_{η} into the data processor 14.1 and to compare the viscosity index K_{η} determined for the current cycle with the loaded target viscosity index K_{η}*.

If the comparison shows that the viscosity index K_{η} determined for the current cycle is in agreement with the target viscosity index K_{η}*, then the manufactured item W produced in the current cycle is identified by the evaluation member 14 as a good part, and accordingly the evaluation member 14 generates a good part marking GM. The manufactured item W produced in the current cycle is marked as a good part by the good part marking GM, which can be displayed as such on the screen of the output member 14.3 visible to the operator of the injection molding machine 1. The good part marking GM for the acceptable part W manufactured during the current cycle, likewise can be stored in the data memory 14.2.

If the comparison reveals a predefined deviation of the viscosity index K_{η} determined for the current cycle from the target viscosity index K_{η}*, then the manufactured item W produced in the current cycle is identified by the evaluation member 14 as a bad part, and the evaluation member 14 accordingly generates a bad part marking BM. The manufactured item W produced in the current cycle is marked as a bad part by the bad part marking GM, which can be displayed as such on the screen of the output member 14.3 visible to the operator of the injection molding machine 1. The bad part marking BM for the unacceptably deviant part W manufactured during the current cycle, likewise can be saved in the data memory 14.2.

The data memory 14.2 stores expert knowledge on injection molding as expert data KD. The expert data KD is digital data. If the viscosity index K_{η} determined for the current cycle differs from the target viscosity index K_{η}*, the computer program CP loaded into the data processor 14.1 is configured to cause the evaluation member 14 to load the expert data KD into the data processor 14.1. The computer program CP is configured to cause the evaluation member 14 to use the loaded expert data KD for generating corrected machine setting data CD that is transmitted to the control member 12 as schematically shown in FIG. 1 for the particular viscosity index K_{η} determined by the evaluation member 14 in the current cycle. By the computer program CP loaded into the data processor 14.1, the evaluation member 14 is configured to load the expert data KD into the data processor 14.1 and to use the loaded expert data KD for generating corrected machine setting data CD for the viscosity index K_{η} determined in the current cycle and transmitting the corrected machine setting data CD to the control member 12 that controls the operating parameters of the injection molding machine 1. In this way, the control member 12 can modify the operation of the injection molding machine 1 to create conditions in the melt M in the cavity 11 for the next cycle more closely in agreement with the target viscosity index K_{η}*.

Thus, the corrected machine setting data CD is used by the control member 12 for correcting the deviation of the viscosity index K_{η} determined for the current cycle from the target viscosity index K_{η}*.

If the deviation is such that the viscosity index K_{η} is too low compared to the target viscosity index K_{η}*, then the corrected machine setting data CD modifies operation of the injection molding machine according to at least one of the following machine setting variables S:
Reducing the metering speed of the screw 10.1,
Reducing the injection speed of the melt M,
Reducing the temperature of the melt M,
Decreasing the filling time point t_{II} from the injection phase I into the holding pressure phase II.

If, however, the deviation is such that the viscosity index K_{η} is too high compared to the target viscosity index K_{η}*, then the corrected machine setting data CD modifies operation of the injection molding machine according to at least one of the following machine setting variables S:
Increasing the metering speed of screw 10.1,
Increasing the injection speed of the melt M,
Increasing the temperature of the melt M,
Delaying the filling time point t_{II} from the injection phase I into the holding pressure phase II.

The corrected machine setting data CD are an instruction for the control member 12 regarding how to correct the deviation of the viscosity index K_{η} determined for the current cycle. The corrected machine setting data CD are digital data. The control member 12 receives the corrected machine setting data CD generated by the evaluation member 14 through the signal lines schematically shown in FIG. 1.

The control member 12 is configured to use the corrected machine setting data CD to modify operation of the injection molding machine 1 for correcting the deviation of the viscosity index K_{η} determined by the evaluation member 14 for the current cycle. To this end, the control member 12 generates at least one of the following corrected machine setting variables CS according to the instructions of the corrected machine setting data CD:
a corrected metering speed of the screw 10.1,
a corrected injection speed of the melt M,
a corrected temperature of the melt M,
a corrected filling time point t_{II} from the injection phase I into the holding pressure phase II.

The corrected machine setting variable CS ensures that the immediately succeeding cycle or a later cycle, operates with a corrected viscosity index K_{η}′ that is closer to, if not equal to, the target viscosity index K_{η}*.

The monitoring of the operation of the injection molding machine 1 by the evaluation member 14 of the device V is repeated for each injection molding cycle. Thus, the evaluation member 14 compares the corrected viscosity index K_{η}′ determined for the immediately succeeding cycle with the target viscosity index K_{η}*. In case of an agreement or a deviation, the steps of generating a good part marking GM or a bad part marking BM as well as the generating of corrected machine setting data CD taken above in the example of a viscosity index K_{η} determined in the current cycle, are repeated.

### LIST OF REFERENCE NUMERALS

1 injection molding machine
10 injection device
10.1 screw
10.2 nozzle
11 injection molding tool
11.1 cavity
12 control member
13 pressure sensor member
14 evaluation member
14.1 data processor
14.2 data memory
14.3 output member
14.4 input member
BM bad part marking
CD corrected machine setting data
CP computer program
CS corrected machine setting variable
ΔP pressure increase
Δt time difference
η viscosity
K_{η} viscosity index
K_{η}′ corrected viscosity index
K_{η}* target viscosity index
GM good part marking
i sensor data index
I injection phase
II holding pressure phase
III cooling phase
INT area
I(tᵢ) specific integral
KD expert knowledge
M melt
n sensor data number
P internal mold pressure
Pᵢₙᵢ initial internal mold pressure
P_{II} filling pressure
Pₘₐₓ maximum internal mold pressure
S machine setting variable
SD machine setting data
t time period
tᵢ time point
t₁ start of injection phase
t_{I} starting time point
t_{II} filling time point
t_{III} sealing point
tₙ end of cooling phase
V device
W manufactured item
XD(tᵢ) sensor data
XD′(tᵢ) first deviation function
XD″(tᵢ) second deviation function
Y(tᵢ) internal mold pressure curve

What is claimed is:

1. A method for operating an injection molding tool that includes a pressure sensor member configured and disposed to measure an internal mold pressure of a melt in at least one cavity and including at least one evaluation member configured for evaluating sensor data generated by the pressure sensor member, the method comprising the following steps:
injecting the melt into the at least one cavity to fill the at least one cavity;
using the pressure sensor member to generate sensor data for the internal mold pressure measured by the pressure sensor member;
using the evaluation member to transform the sensor data into a pressure function that is a time varying function of the internal mold pressure in the at least one cavity being filled with the melt;
using the evaluation member to determine a starting time point where the sign of a first derivative function of the pressure function changes from zero to positive (>0);
using the evaluation member to determine a filling time point where the sign of a second derivative function of the sensor data changes from zero to positive (>0);
using the evaluation member to calculate a pressure increase between the internal mold pressure at the filling time point and the internal mold pressure at the starting time point;
using the evaluation member to calculate a viscosity index from said pressure increase and a time difference between the filling time point and the starting time point;
using the evaluation member to generate a comparison between the calculated viscosity index and a target viscosity index that correlates with production of an acceptable part in the at least one cavity; and
adjusting at least one operating parameter of the injection molding tool based on the comparison.

2. The method according to claim 1, wherein the evaluation member calculates the viscosity index from a specific integral of the sensor data between the filling time point and the starting time point.

3. The method according to claim 1, wherein the evaluation member represents the sensor data in a coordinate system as a graph of the pressure function, which coordinate system comprises an ordinate and an abscissa, which ordinate represents the measured internal mold pressure and which abscissa represents the time points of the generated sensor data; and wherein the evaluation member calculates the viscosity index as the area under the graph of the pressure function and the abscissa between the filling time point and the starting time point.

4. The method according to claim 1, wherein the evaluation member selects a target viscosity index from a plurality of target viscosity indexes and wherein each of the plurality of target viscosity indexes is correlated with an acceptable part produced from a different melt.

5. The method according to claim 4, further comprising operating the injection molding machine repeatedly over a plurality of successive cycles over time to produce a respective part in the at least one cavity during each of the plurality of successive cycles;
wherein the evaluation member compares the viscosity index determined for each of the plurality of successive cycles with the target viscosity index;
wherein the evaluation member generates a good part marking for the part when the comparison shows that the viscosity index determined for the respective cycle of the plurality of successive cycles is in agreement with the target viscosity index; and
wherein the evaluation member generates a bad part marking for the part when the comparison shows that the viscosity index determined for the respective cycle of the plurality of successive cycles deviates from the target viscosity index.

6. The method according to claim 5, wherein when the comparison shows that the viscosity index determined for the respective cycle of the plurality of successive cycles deviates from the target viscosity index, then based on the viscosity index determined in the respective cycle of the plurality of successive cycles the evaluation member generates corrected machine setting data for adjusting the at least one operating parameter of the injection molding tool.

7. The method according to claim 6, wherein the evaluation member transmits the corrected machine setting data to a control member configured for controlling the production of the part in the at least one cavity of the injection molding tool of the injection molding machine.

8. A device for aiding control of an injection molding machine to produce a consistent part from at least one cavity that molds the part from an injection of a melt from an injection molding tool, wherein the injection molding machine includes a control member configured for controlling the production of the part in accordance with at least one machine setting variable, the device comprising:
a pressure sensor member arranged at the at least one cavity and configured to measure an internal mold pressure of the injected melt within the cavity and to generate sensor data for the internal mold pressure measured;
an evaluation member configured for evaluating the sensor data to produce an evaluation that:
determines a starting time point where the sign of a first derivative function of the sensor data changes from zero to positive (>0);
determines a filling time point where the sign of a second derivative function of the sensor data changes from zero to positive (>0);
calculates a pressure increase between the internal mold pressure at the filling time point and the internal mold pressure at the starting time point; and
calculates the viscosity index from said pressure increase and the time difference between the filling time point and the starting time point.

9. The device according to claim 8, wherein the evaluation calculates the viscosity index from the specific integral of the sensor data between the filling time point and the starting time point.

10. The device according to claim 8, wherein the evaluation represents the sensor data as a graph of a function in a coordinate system, wherein said coordinate system comprises an ordinate and an abscissa, which ordinate represents the measured internal mold pressure and which abscissa represents the time points of the generated sensor data; and wherein the evaluation calculates the viscosity index as the area under the graph of a function and the abscissa between the filling time point and the starting time point.

11. The device according to claim 8, wherein the evaluation member is configured for determining a target viscosity index at which the injection molding machine produces a manufactured item of a quality that conforms to a predetermined norm of a so-called good part.

12. The device according to claim 11, wherein the evaluation member is configured for comparing the viscosity index determined for a current cycle that produces a manufactured item with the target viscosity index; wherein the evaluation member is configured to generate a good part marking when the comparison shows that the viscosity index determined for the current cycle is in agreement with the target viscosity index, and the manufactured item produced in the current cycle is a good part; and wherein the evaluation member is configured to generate a bad part marking when the comparison shows a deviation of the viscosity index determined for the current cycle from the target viscosity index, and the manufactured items produced in the current cycle is a bad part.

13. The device according to claim 12, wherein the evaluation member is configured to use expert data for generating corrected machine setting data for the viscosity index determined in the current cycle when the comparison shows a predefined deviation of the viscosity index determined for the current cycle from the target viscosity index.

14. The device according to claim 13, wherein the evaluation member is configured so that if the deviation is such that the viscosity index is too low compared to the target viscosity index, then the evaluation member is configured to generate the corrected machine setting data that will instruct at least one of the following machine setting variables:
Reducing a metering speed of a screw,
Reducing an injection speed of the melt,
Reducing a temperature of the melt,
Decreasing the filling time point from an injection phase into a holding pressure phase;
or wherein if the deviation is such that the viscosity index is too high compared to the target viscosity index, then the corrected machine setting data generated by the evaluation member will instruct at least one of the following machine setting variables:
Increasing a metering speed of a screw,
Increasing an injection speed of the melt,
Increasing a temperature of the melt,
Delaying the filling time point from an injection phase into a holding pressure phase.

15. The device according to claim 13, wherein the evaluation member is configured to transmit the corrected machine setting data to the control member of the injection molding machine to adjust at least one of the following machine setting variables:
a metering speed of a screw,
an injection speed of the melt,
a temperature of the melt, and
a filling time point from an injection phase into a holding pressure phase.

16. The device according to claim 14, wherein the evaluation member is configured to transmit the corrected machine setting data to the control member of the injection molding machine to adjust at least one of the following machine setting variables:
a metering speed of a screw,
an injection speed of the melt,
a temperature of the melt, and
a filling time point from an injection phase into a holding pressure phase.
